(19) United States
(12) Patent Application Publication
(10) Pub. No.: US 2011/0179025 A1
(43) Pub. Date: Jul. 21, 2011

(54) SOCIAL AND CONTEXTUAL SEARCHING FOR ENTERPRISE BUSINESS APPLICATIONS

(75) Inventor: Alfred S. CHUANG, Los Altos Hills, CA (US)

(73) Assignee: KRYPTONITE SYSTEMS INC, Palo Alto, CA (US)

(21) Appl. No.: 12/691,621

(22) Filed: Jan. 21, 2010

(51) Int. Cl. G06F 17/30

(52) U.S. Cl. 707/728; 707/E17.064

(57) ABSTRACT

A process for performing a search of data includes creating a search index of a data base system comprising data associated with an enterprise business application (e.g., a Customer Relationship Management (CRM) application) and user information associated with a plurality of users of the enterprise business application. The process searches the database system via the search index based on a received search query from a first user of the plurality of users, and determines the relevancy of identified search results to the first user based on one or more attributes of the first user (e.g., an algorithm that takes into account user profile information, social network information, strength of contact or connection to other users, and so on). The process further includes communicating at least a portion of the search results to the first user for display.

### BACKGROUND

1. Field

This application relates generally to systems and processes for searching data, and in one particular example, to computer systems and processes for social and contextual searches within enterprise business applications.

2. Related Art

The Internet and other networks interconnect computers and computing devices to allow for easy transport of data over network connections. Commonly, computers and computing devices are organized using well known client-server models, where network connections are established between some computers or computing devices that act as servers and some computers or computing devices that act as clients. An example of a server is a web server and an example of a client is a web client such as a personal computer device running a web browser program. Generally, a web client operates according to the interface to issue requests to web servers, using well known (or other suitable) protocols. In response to requests received, web servers return data responses. In a typical web client-server interaction, HTTP protocol is used, wherein the web client issues a request directed at a particular web server address for a page represented by a URL in the request and a server responsive to the particular web server address responds with data that may be a page to be displayed or other data set. Generally, regardless of the actual data being requested and returned, the data returned is referred to as a web page.

Web pages often include interfaces for searching data; for example, a set of data from a particular source or sources based on a previously generated indexing of the data. A web interface might search for web pages, other users, documents, media objects (e.g., text files, image files, video files, audio files, and so on), products, and so on. Typically a user may enter search criteria (such as keywords or attributes) and the server returns search results, generally by generating a top-down relevancy order based on the search criteria and a particular searching algorithm.

The ordering of search results according to the search criteria and particular searching algorithm may not always rank the most relevant results to a particular user at or near the top of the results page. Search results are typically ranked based solely on a “relevancy” score given by the search engine. For example, a relevancy score is generally calculated using a standard information retrieval algorithm based on many factors, but primarily the degree of match with keywords the search is based upon. While relevancy scores may be useful in the overall rankings of search results, such search engines fail to include many factors outside the scope of the index into consideration, such as the context or information associated with a user making the search request.

### SUMMARY

In one exemplary embodiment, a process for performing a search of data includes creating a search index of a data base system comprising data associated with an enterprise business application (e.g., a Customer Relationship Management (CRM) application) and user information associated with a plurality of users of the enterprise business application. The process searches the database system via the search index based on a received search query from a first user of the plurality of users, and determines the relevancy of identified search results to the first user based on one or more attributes of the first user (e.g., an algorithm that takes into account user profile information, social network information, strength of contact or connection to other users, and so on). The process further includes communicating at least a portion of the search results to the first user for display.

Determining relevancy of search results may include determining which results are associated with the first user (e.g., search results that include user documents and information) and returning or displaying those first, followed by search results associated with contacts of the first user, followed by search results associated with users or groups of the first user's social network, and so on. In other examples, determining relevancy may include calculating a relevancy score and ordering the search results according to the score. Determining relevancy may include weighting search results associated with the first user greater than other search results. Further, determining relevancy may include weighting search results including information associated with other users based on a degree of contact (or connection strength) between the first user and the other users, wherein the greater the degree of contact the more heavily weighted the search result.

According to another exemplary embodiment, a process for determining connection strength between users of an application is provided. The process may include receiving a request from a first user, the request associated with a second user, e.g., a request for the second user directly or in response to a more general search request. The process identifies a third user having a first connection strength to the first user and a second connection strength to the second user, wherein at least one of the strength or relative strength of the first connection strength and the second connection strength is displayed to the first user. The connection strength may be determined by an underlying algorithm; for example, the strength of connection of the first connection and the second connection can be based on a degree of contact between the first user and the third user and the second user and the third user, respectively, wherein the greater the degree of contact the greater the strength of connection.

According to other embodiments, systems, apparatuses, and computer-readable storage media comprising computer-readable instructions for searching data are provided. For example, a computer-readable storage medium may include computer-readable instructions for one or more of indexing a data base system comprising data associated with an enterprise business application (e.g., a CRM application) and user information associated with a plurality of users of the enterprise business application, searching the database system via the search index based on a received search query from a first user, determining the relevancy of search results to the first user based on one or more attributes of the first user, and communicating at least a portion of the search results to the first user for display.

In other examples, computer-readable instructions for determining connection strength between users is provided. For example, a computer-readable storage medium may include computer-readable instructions for one or more of receiving a request from a first user (the request associated with a second user), identifying a third user having a connection to the first user and the second user, and determining a first connection strength to the first user and a second connection strength to the second user, wherein at least one of the strength or relative strength of the first connection strength and the second connection strength is displayed to the first user. The connection strength may be determined by an underlying algorithm; for example, the strength of connection of the first connection and the second connection can be based on a degree of contact between the first user and the third user and the second user and the third user, respectively, wherein the greater the degree of contact the greater the strength of connection.

### BRIEF DESCRIPTION OF THE FIGURES

The present application can be best understood by reference to the following description taken in conjunction with the accompanying drawing figures, in which like parts may be referred to by like numerals.

FIG. 1 illustrates an exemplary environment in which certain aspects and examples of the user interfaces, apparatuses, and processes described herein may operate.

FIG. 2 illustrates an exemplary process for creating a search index and searching data based on the context of a user.

FIG. 3 illustrates an exemplary process for determining connection strength between different users and relevancy of search results to a particular user.

FIG. 4 illustrates an exemplary process and display illustrating user(s) between a user making a search request and user(s) being search, including the connection strength thereto.

FIG. 5 illustrates an exemplary computing system.

### DETAILED DESCRIPTION

The following description sets forth numerous specific configurations, parameters, and the like. It should be recognized, however, that such description is not intended as a limitation on the scope of the present invention, but is instead provided as a description of exemplary embodiments.

With the exponential growth of information available on the Web, search engine technology is trying to provide ever improving algorithms to return increasingly relevant search results to users. Current search technology, however, generally does not provide highly relevant search results for users of enterprise business applications. For instance, relevancy from typical consumer search engines fails to consider the context of the user, such as a user in a sales position, utilizing an enterprise business application. Additionally, a typical consumer search engine fails to utilize data associated with users of an application, e.g., profile and contextual information, of the user making a request and the other users of the application.

In one exemplary process provided herein, a search system indexes information associated with an application and users of the application, and uses information about a user making a search request to determine relevancy of search results and rank or display the search results accordingly. For example, processes may learn about users of an application by tracking or indexing information about the users, e.g., indexing users' profile information, social networks (e.g., including contacts or connections, users associated with a group, deal, etc. in common with the first user), and interactions with the business applications being utilized. For instance, a user of a business enterprise application, such as a Customer Relationship Management (CRM) application, will generate or create user specific information (e.g., profile information, contacts and connections, application data and documents, messages, communications between users in the application, deal groups, etc.). The user-specific information can be indexed for searching and used for determining relevancy of search results to particular users.

In one example, the process indexes application data and user data, and processes search requests on a widening concept. That is, by indexing information from the users and the application, the search process may return search results from or associated with the user making the request first (or weighted heavily in a relevancy algorithm), followed by search results associated with or collected from other users with whom the first user is connected to in some manner, and followed by search results associated with an iterative expansion of the social network. Such exemplary processes may improve the relevancy of the search results for the particular search requester by returning information more closely associated with the user as more highly relevant than other information, information associated with a user's contacts or connections as more relevant than information not associated with a user's contacts, and so on.

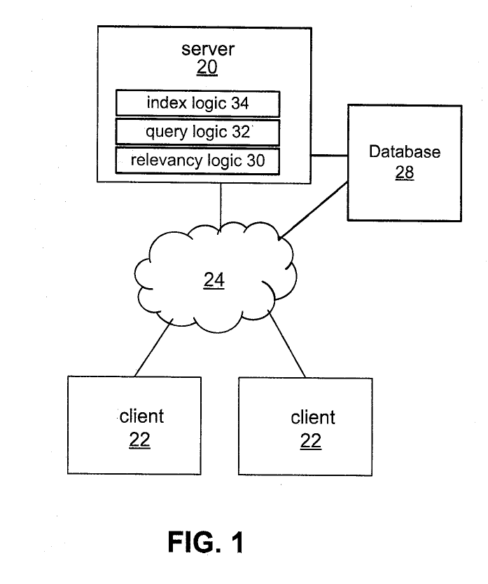

Initially, and with reference to FIG. 1, an exemplary environment in which certain aspects and examples of the user interfaces, apparatuses, and processes described herein may operate. Generally, one or more clients 22 may access a server 20, which includes or accesses logic for performing one or more exemplary processes described, e.g., retrieving search requests; indexing databases, searching, querying, causing the display of a search interface, and so on. Server 20 and clients 22 may include any one of various types of computer devices, having, e.g., a processing unit, a memory (which may include logic or software for carrying out some or all of the functions described herein), and a communication interface, as well as other conventional computer components (e.g., input device, such as a keyboard/keypad and/or mouse, output device, such as display). For example, client 22 may include a desktop computer, laptop computer, mobile device such as a mobile phone, web-enabled phone, smart phone, television, television set-top box, and the like.

Clients 22 and server 20 may communicate, e.g., using suitable communication interfaces via a network 24, such as a Local Area Network (LAN) or the Internet. Clients 22 and server 20 may communicate, in part or in whole, via wireless or hardwired communications, such as Ethernet, IEEE 802.11b wireless, or the like. Additionally, communication between clients 22 and server 20 may include or communicate with various servers such as a mail server, mobile server, media server, and the like.

Server 20 generally includes logic (e.g., http web server logic) or is programmed to format data, accessed from local or remote databases or other sources of data and content, for presentation to users of clients 22, preferably in the format described herein. For example, server 20 may format data and/or access a local or remote database to communicate and cause the display of an interface to clients 22, data related to objects for display within an interface (which may include a search interface and display window for displaying objects, for example), links to additional information and/or content related to the objects, the additional content and/or information itself, and the like.

To this end, server 20 may utilize various web data interface techniques such as Common Gateway Interface (CGI) protocol and associated applications (or “scripts”), Java® “servlets”, i.e., Java® applications running on a web server, or the like to present information and receive input from clients 22. The server 20, although described herein in the singular, may actually comprise plural computers, devices, databases, associated backend devices, and the like, communicating (wired and/or wireless) and cooperating to perform some or all of the functions described herein. Server 20 may further include or communicate with account servers (e.g., email servers), mobile servers, photo servers, video servers, and the like.

Further, web pages communicated to client 22 may include various text and media objects such as articles, documents, photos, audio files, video files, and the like. Additionally, the content may include selections or links to further content accessible by the interface and associated user device, e.g., via Application Programming Interfaces (APIs), web pages, and the like stored or accessed locally or remotely. Content accessible by client 22 via a presented web page (within the search result display tiles or accessible via the search result display tiles) may conform to any suitable data format including various media formats such, e.g., still image (e.g., JPEG, TIFF), video (e.g., MPEG, AVI, Flash), or audio (e.g., MP3, OGG).

In one example, server 20 may further include or communicate with logic for implementing a web-based CRM system. For example, server 20 may include one or more application servers configured to implement and execute CRM software applications as well as provide related data, code, forms, web pages, and other information to and from clients 22 and to store to, and retrieve from, a database system related data, objects and web page content. To this end, server 20 may include or communicate with query logic 32, or communicate with one or more query servers, and a database system 28 (e.g., one or more databases and/or tenant databases). Server 20 may also include or communicate with index logic 34, which may process queries and index database 28. Broadly speaking, index logic 34 operates to query and index at least database 28 for use during searches of application data and user data. For example, in response to receiving a query form a client 22, index logic 34 reads the created index(es) of database 28 to determine matches to the search query.

Server 20 further includes or communicates with relevancy logic 30. Search results are returned or retrieved with a relevancy score or ranking as determined by the relevancy logic 30, which includes or communicates with an underlying search algorithm. Relevancy logic 30 may include one or more algorithms for determining the relevancy of search results to the user making the search request, e.g., by taking into account a user's associated information and context with respect to other users within a business application when returning search results. For example, the user's data, which has been indexed and made part of the data to be searched, is searched and provides input into the search query. For example, the search results are ordered or weighted to make the user's information and information associated with a user's connections prioritized as more relevant than information associated with other users as described in greater detail below.

It should be appreciated that index logic 34 (e.g., an indexer) can be implemented in a separate server or computer system or it may be implemented or may execute within server 20 or in an application server, and multiple indexers may execute in different systems. Similarly, query logic 32 (e.g., a querier) and relevancy logic 30 may be implemented or may execute in a separate server or computer system or may be implemented or may execute in server 20 or an application server.

It should be noted that although the exemplary methods and systems described herein describe use of a separate server and database for performing various functions, other embodiments could be implemented by storing the software or programming that operates to cause the described functions on a single device or any combination of multiple devices as a matter of design choice so long as the functionality described is performed. Although not depicted in the figures, server 20 generally includes such art recognized components as are ordinarily found in server systems, including but not limited to processors, RAM, ROM, clocks, hardware drivers, associated storage, and the like (see, e.g., FIG. 9, discussed below). Further, the described functions and logic may be included in software, hardware, firmware, or combination thereof.

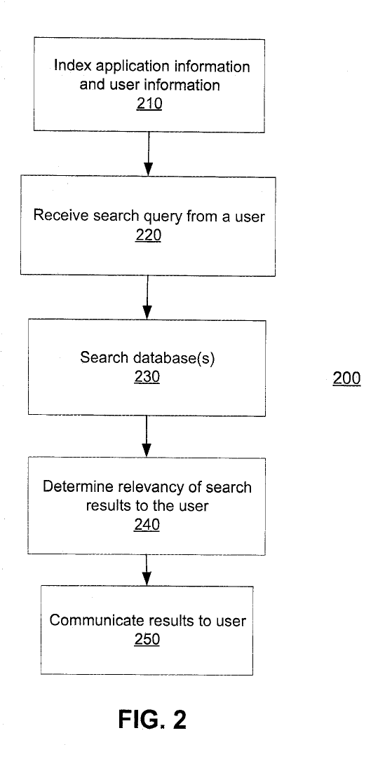

FIG. 2 illustrates an exemplary process 200 for creating an index and searching a database system. Initially, at 210, an index is created of the appropriate database(s) and information. For example, exemplary process 200 initially creates an index of data or records associated with an enterprise business application, e.g., a CRM application or the like. The process further indexes data associated with the users of the application, e.g., including user profile information, messages, contacts, actions within the system, and so on. The index can be updated or recreated dynamically, as data is added to or changed within the relevant databases, to include recent application and user data. Alternatively, the index can be updated or recreated at a predetermined time interval, e.g., daily, weekly, and so on.

The process receives a search request from a user at 220. In one example, the search request comprises a simple boolean search request for keywords. Of course, the search request may take various forms and include many different selectable fields and attributes. The process searches the data base system based on the search index and the received search query at 230. The search of the database system identifies matches to the search request.

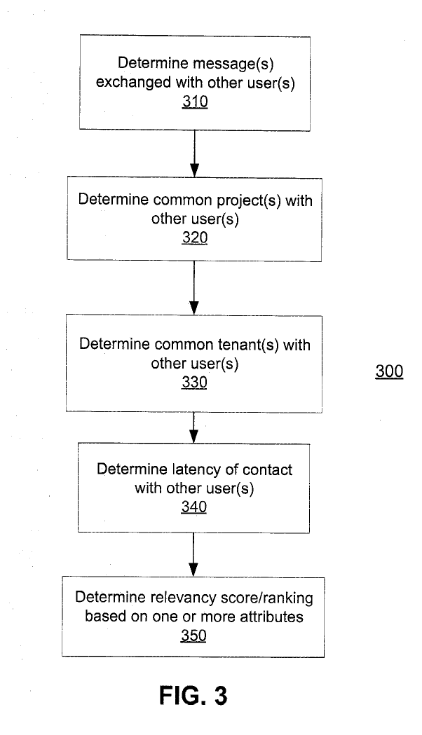

The process then determines the relevancy of the identified or returned search results at 240. In one example, the relevancy is determined with respect to the first user based on a search or relevancy algorithm, where the algorithm considers one or more attributes of the user making the request (an exemplary algorithm is described with respect to FIG. 3). For example, scoring documents associated with the user as highly relevant, followed by search results associated with a user's connections, followed by users within a social network or group, and so on. The process then communicates at least a portion of the search results to the first user for display at 250 based on the relevancy. The process may initially communicate, for example, the most relevant 10 or 25 search results, to the user, where additional search results may be requested by the user.

Note that in other examples, without weighting or scoring the search results, search results associated with the user making the request may be returned first, followed by search results associated with a user's connections, followed by users within a social network or group, and so on. The particular order of the search results within the different levels or degrees of search results (e.g., associated with a user, associated with connections having 1 degree of separation, and so on) may be determined by the underlying search used to identify the search results in 230.

FIG. 3 illustrates an exemplary process 300 for determining relevancy of search results to a particular user. In this example, the degree of contact or separation and connection strength between users within the network can be determined and used for weighting the search results. For example, search results associated with other users can be ranked or scored, at least in part, based on the degree or strength of contact with the user making the search request. That is, the exemplary process takes into account the context of the user relative to the business application and other users of the business application in determining a relevancy score or ranking of search results. Application data may include various applications and media objects related to a business enterprise application. With respect to a CRM application, for example, such data may include deals created by the CRM application, including the deal name, deal description, deal size, related documents, users associated therewith, and company name. User data may include each user's profile information, e.g., including their profile information, contacts/connections, name and frequency of deal participation, messages posted, document published, emails or messages exchanged, social networks or groups, and so on. All emails, personal notes, and alerts messages may be indexed for searching.

In this particular example, the process identifies users the user making the search request has exchanged messages with at 310, e.g., email, instant messages, voice over IP phone calls, web conferences, or other types of communications. The type of communication and number of communications or messages exchanged with other users may also be determined for weighting within an algorithm. For example, instant messages might be weighted more heavily than emails between users.

The exemplary process may further identify users having common projects with the user making the request at 320. For example, identifying other users working on common deals. Again, the number of deals, size of the deal, number of users involved in the deal, etc., may also be considered.

The exemplary process may further determine users having a common tenant or company with the user making the request at 330. For example, users having a common tenant may be weighted more heavily for relevancy.

The exemplary process may further determine the latency of the contact with the other users at 340. For instance, wither respect to messages or communications at 310, common projects at 320, and so on, more weight can be given to more recent interactions or items, and less weight to more distant interactions or items.

The process may then determine relevancy of the search results to the user based on the determinations made in 310, 320, 330, and 340. For example, an algorithm may determine a score or ranking of the search results based on the degree of contact determined between the first user and second users associated with the search results. The search results may then be ordered in a top-down relevancy order (e.g., based on a scoring or ranking) for communication and display to the user. It should be recognized that the exemplary process 300 may include other or additional considerations for relevancy, which may be used in various combinations. For example, various other social or contextual data may be used to determine relevancy to a particular user. Further, the determinations made in 310, 320, 330, and 340 need not occur in any particular order and may be made in parallel.

An exemplary algorithm for weighting the determinations, or calculating the connection strength of a user with other users in a network, may take various forms. An exemplary algorithm for implementing the process described with respect to FIG. 3 may include 4 attributes as input, where a weight will be given for each attribute as follows:

Attribute 1—Messages exchanged (weighted W_{A}%): A check for the messages exchanged between two users. For example, if the number of messages exchanged is within top 20% of messages exchanged by a particular or average user (or other predetermined percentage or number), the score is 5. Otherwise the score will be 4 for 20%-40%, 3 for 40%-60%, 2 for 60%-80% and 1 for the bottom 20% and 0 if no messages exchanged between the users.

Attribute 2—Projects joined by both users (weighted W_{B}%): A check of the number of deals joined by both users. For example, if the number of deals is within top 20% of the particular or average user, the score is 5. Otherwise the score will be 4 for 20%-40%, 3 for 40%-60%, 2 for 60%-80%, 1 for the bottom 20% and 0 if no common deals.

Attribute 3—Same tenant (weighted W_{c}%): Score 1 if the two users are in the same tenant, otherwise the score is 0.

Attribute 4—Latest message exchange time (weighted W_{D}%): If the latest message exchange time is within the same week (or other time period), the score is 4. The score is 3 if within same month, 2 within same quarter, 1 within the same year, and 0 for no messages exchanged.

The total connection strength S between the two connections can be thus calculated as:

S=(Attribute 1)/5×W_{A}% +(Attribute 2)/5×W_{B}% +(Attribute 3)×W_{C}% +(Attribute 4)/4×W_{D}%

The connection strength S may then be used to order the relevancy of the search results, thereby providing a relevancy ranking or order to the search results relative to the particular use making the search request. It should be understood, that various other weighting schemes and additional items and combinations thereof may be used to determine connection strength and relevancy. For example, similar deals, other types of communications, social network data, and so on may also be used in various combinations and weights to determine connection strength and relevancy.

Further, a user and/or administrator of an application or social network system may adjust the algorithm and weightings for determining connections strength. For instance, a user may decide to change the number or kind of attributes, as well as the particular weighting each attribute receives in determining connection strength. As such, a user may decide the number of messages and latency of user messages between users is most important and either heavily weight those attributes or only include those attributes in the algorithm.

In addition to searching across all data associated with a business application and users of the business application, a search for particular users may be performed. Such a search may be sorted for relevance as described above, e.g., based on an algorithm weighting relevancy to the particular user making the search. Additionally or alternatively, the exemplary system may provide information regarding users connected between the user making the search and users returned by the search to facilitate connections or communications with other users. For example, the system may determine other user's that have strong connections to the users being searched and the user making the search.

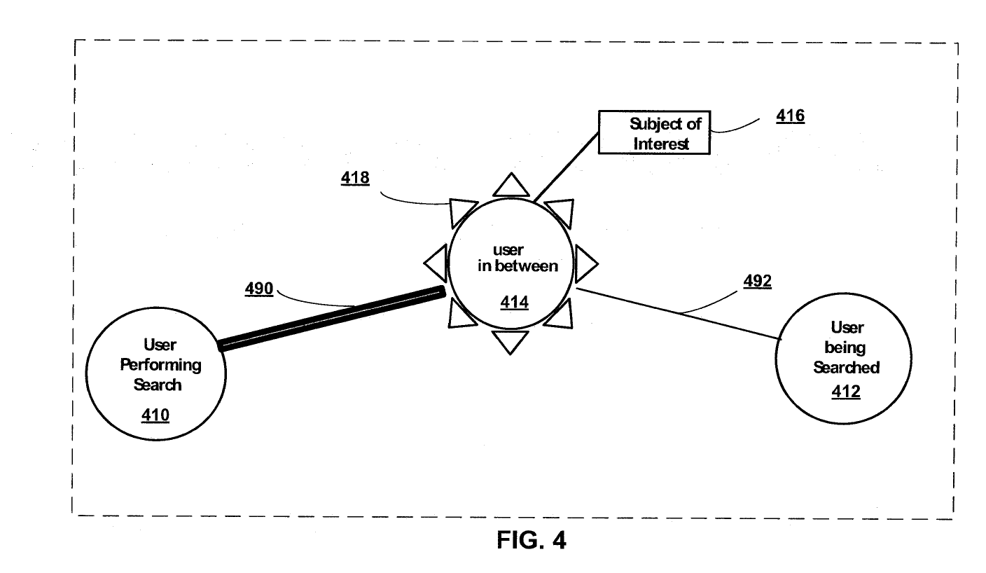

FIG. 4 illustrates an exemplary display (e.g., via a served Web page or the like) of the connections and connection strength between a user making a search and a user(s) being searched or otherwise selected. For example, in response to a search query or selection of a particular user by a first user, data or a display may be returned to illustrate one or more other users connected between the first user and the user being searched. Further, the data or display may indicate the degree or strength of connection between the relative users (e.g., by using the connection strength algorithm described).

Identifying users that may have a strong connection with a user being searched may assist the searcher in identifying a contact or user in their social network that may be able to provide an introduction to the person being searched. As such, providing strength of connection indication allows a user to focus on their contacts or social networked users that have a higher likelihood of being able to provide a meaningful introduction relative to a random connection that is also a connection of the user being searched.

Generally, the display includes an icon of the first user 410 making the request, an icon of the second user 412 that is being searched or returned by a search request, and an icon of at least one user 414 in between that is connected to both the first user 410 and the second user 412. In some examples, user 414 may not be directly “connected” or a “contact” of both users 410 or 412, but merely have some degree of contact, e.g., via a common group or interest. In some examples, only one user 414 is displayed between user 410 and 412, e.g., selected based on the strength of connection between user 410, user 412, or a combination thereof. In other examples, two or more users 414 may be displayed. Similarly, multiple second users 412 being searched may be displayed. Further, the various users 410, 412, and 414 may be displayed in other forms, tables, and so on, and may include images or additional information regarding each user.

Connection strength is illustrated in this example by the thickness of lines 490 and 492 connecting user 410 to user 414 and user 414 to user 412, where increasing width indicates an increasing strength of connection. The strength of connection may be based on the algorithm described above for determining a strength of connection based on factors such as messages exchanged there between, common deals or tenant, latency, common interests, and so on. It should be understood that other manners of showing the connection strength are possible and contemplated. For example, a relative score, color, closeness of the users, and so on may be used. Also, as described above, a user may adjust the process for determining the connection strength, e.g., by changing the input attributes, weightings, and so on.

Additionally, the exemplary system may indicate if user 414 has a common interest or group with user 410 and/or user 412. For example, a text window 416 may indicate that user 414 is interested in a particular subject or group that is in common with user 410 and/or user 412.

Additionally, the exemplary system may indicate the popularity of user 414, which may be illustrated or conveyed in multiple ways. For example, a graphical icon 418 may be used, a listing of the number of contacts or social groups associated with user 414, requests for introductions to other users, and so on. This may assist user 410 in determining how social or connected user 414 is within the application and environment.

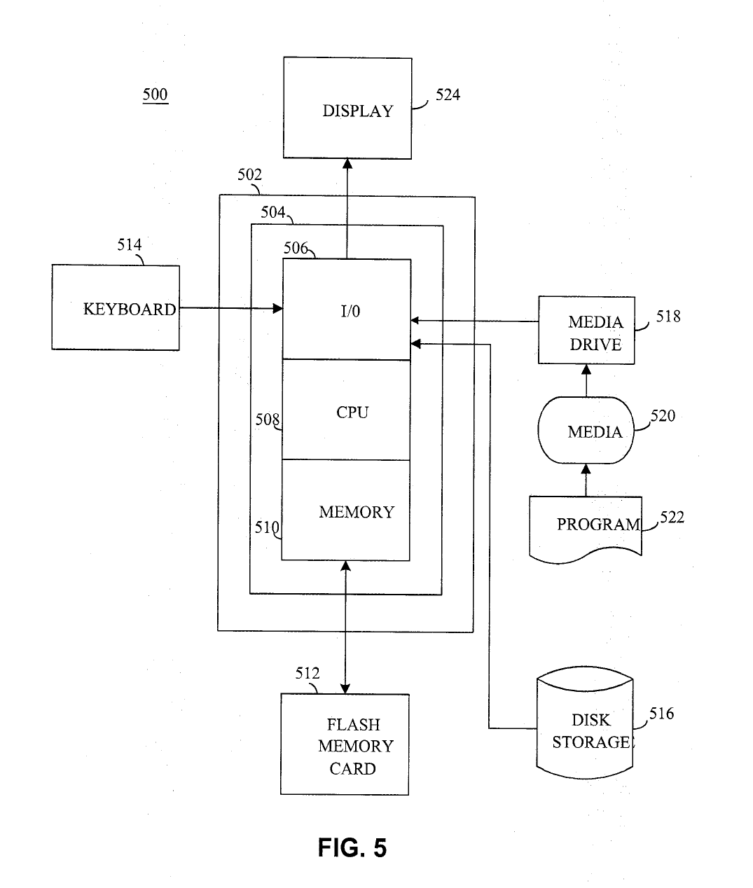

FIG. 5 depicts an exemplary computing system 500 configured to perform any one of the above-described processes. In this context, computing system 500 may include, for example, a processor, memory, storage, and input/output devices (e.g., monitor, keyboard, disk drive, Internet connection, etc.). However, computing system 500 may include circuitry or other specialized hardware for carrying out some or all aspects of the processes. In some operational settings, computing system 500 may be configured as a system that includes one or more units, each of which is configured to carry out some aspects of the processes either in software, hardware, or some combination thereof.

FIG. 5 depicts computing system 500 with a number of components that may be used to perform the above-described processes. The main system 502 includes a motherboard 504 having an input/output (“I/O”) section 506, one or more central processing units (“CPU”) 508, and a memory section 510, which may have a flash memory card 512 related to it. The I/O section 506 is connected to a display 524, a keyboard 514, a disk storage unit 516, and a media drive unit 518. The media drive unit 518 can read/write a computer-readable medium 520, which can contain programs 522 and/or data.

At least some values based on the results of the above-described processes can be saved for subsequent use. Additionally, a computer-readable medium can be used to store (e.g., tangibly embody) one or more computer programs for performing any one of the above-described processes by means of a computer. The computer program may be written, for example, in a general-purpose programming language (e.g., Pascal, C, C++) or some specialized application-specific language.

Although only certain exemplary embodiments have been described in detail above, those skilled in the art will readily appreciate that many modifications are possible in the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

What is claimed is:

1. A computer-enabled method of performing a search of data, the method comprising:
indexing, by a computer processer, a data base system comprising data associated with a Customer Relationship Management (CRM) application and user information associated with a plurality of users of the CRM application;
searching the database system via the search index based on a received search query from a first user of the plurality of users;
determining relevancy of search results to the first user based on one or more attributes of the first user; and
communicating at least a portion of the search results to the first user for display.

2. The method of claim 1, wherein determining the relevancy of the search results comprises calculating a relevancy score and ordering the search results according to the score.

3. The method of claim 1, wherein determining the relevancy of the search results comprises retrieving search results comprising information associated with the first user as more relevant than other search results.

4. The method of claim 1, wherein determining the relevancy of the search results comprises weighting search results comprising information associated with at least a second user based on a degree of contact between the first user and the at least a second user, wherein the greater the degree of contact the more heavily weighted the search result.

5. The method of claim 1, wherein determining the relevancy of the search results comprises determining a connection strength with at least a second user associated with one or more of the search results.

6. The method of claim 1, wherein determining relevancy comprises weighting search results associated with contacts of the first user greater than search results associated social network users that are not direct contacts of the first user.

7. The method of claim 1, wherein the one or more attributes of the first user comprises user profile information of the first user.

8. The method of claim 1, wherein the one or more attributes of the first user comprises information indicating connection strength to at least one other user.

9. A computer-enabled method of providing connection strength between users of an application, the method comprising:
receiving a request from a first user, the request associated with a second user; and
identifying a third user having a first connection strength to the first user and a second connection strength to the second user, wherein at least one of the strength or relative strength of the first connection strength and the second connection strength is communicated to the first user for display.

10. The method of claim 9, wherein the strength of connection of the first connection and the second connection is based on a degree of contact between the first user and the third user and the second user and the third user, respectively, wherein the greater the degree of contact the greater the strength of connection.

11. The method of claim 9, wherein the first user is not a connection of the second user, and the third user is a connection of both the first user and the second user.

12. Computer-readable storage medium comprising computer-executable instructions for searching data associated with a Customer Relationship Management (CRM) application, the instructions comprising:
indexing data associated with a CRM application and user information associated with a plurality of users of the CRM application;
searching the indexed data based on a received search query from a first user of the plurality of users;
determining relevancy of search results to the first user based on one or more attributes of the first user; and
communicating at least a portion of the search results to the first user.

13. The computer-readable medium of claim 12, wherein determining the relevancy of the search results comprises calculating a relevancy score and ordering the search results according to the score.

14. The computer-readable medium of claim 12, wherein determining the relevancy of the search results comprises retrieving search results comprising information associated with the first user as more relevant than other search results.

15. The computer-readable medium of claim 12, wherein determining the relevancy of the search results comprises weighting search results comprising information associated with at least a second user based on a degree of contact between the first user and the at least a second user, wherein the greater the degree of contact the more heavily weighted the search result.

16. The computer-readable medium of claim 12, wherein determining the relevancy of the search results comprises determining a connection strength with at least a second user associated with one or more of the search results.

17. Computer-readable storage medium comprising computer-executable instructions for providing connection strength between users of an application, the instructions comprising:
receiving a request from a first user, the request associated with a second user;
identifying a third user having a first connection strength to the first user and a second connection strength to the second user, wherein at least one of the strength or relative strength of the first connection strength and the second connection strength is displayed to the first user.

18. The computer-readable medium of claim 17, wherein the strength of connection of the first connection and the second connection is based on a degree of contact between the first user and the third user and the second user and the third user, respectively, wherein the greater the degree of contact the greater the strength of connection.

19. The computer-readable medium of claim 17, wherein the first user is not a connection of the second user, and the third user is a connection of both the first user and the second user.

20. Apparatus for searching data within a Customer Relationship Management (CRM) application, the apparatus comprising:
a computer processor;
a memory configured to store data; and
a computer-readable medium having computer-executable instructions for:
indexing data associated with a CRM application and user information associated with a plurality of users of the CRM application;
searching the indexed data based on a received search query from a first user of the plurality of users;
determining relevancy of search results to the first user based on one or more attributes of the first user; and
communicating at least a portion of the search results to the first user.

21. The apparatus of claim 20, wherein determining the relevancy of the search results comprises calculating a relevancy score and ordering the search results according to the score.

22. The apparatus of claim 20, wherein determining the relevancy of the search results comprises retrieving search results comprising information associated with the first user as more relevant than other search results.

23. The apparatus of claim 20, wherein determining the relevancy of the search results comprises weighting search results comprising information associated with at least a second user based on a degree of contact between the first user and the at least a second user, wherein the greater the degree of contact the more heavily weighted the search result.

24. The apparatus of claim 20, wherein determining the relevancy of the search results comprises determining connection strength with at least a second user associated with one or more of the search results.

25. Apparatus for providing connection strength between users of an enterprise business application, the apparatus comprising:
a computer processor;
a memory configured to store data; and
a computer-readable medium having computer-executable instructions for:
receiving a request from a first user, the request associated with a second user;
identifying a third user having a first connection strength to the first user and a second connection strength to the second user, wherein at least one of the strength or relative strength of the first connection strength and the second connection strength is displayed to the first user.

26. The apparatus of claim 25, wherein the strength of connection of the first connection and the second connection is based on a degree of contact between the first user and the third user and the second user and the third user, respectively, wherein the greater the degree of contact the greater the strength of connection.

27. The apparatus of claim 25, wherein the first user is not a connection of the second user, and the third user is a connection of both the first user and the second user.
